(19) United States
(12) Patent Application Publication
(10) Pub. No.: US 2004/0161303 A1
(43) Pub. Date: Aug. 19, 2004

(54) Catenary anchor leg mooring system

(76) Inventors: Jaap De Baan, Maassluis (NL); Ries Uittenbogaard, Kamerik (NL); Louis Coulomb, Rijswijk (NL)

Correspondence Address: Alan R. Thiele, JENKENS & GILCHRIST, P.C., Suite 3200, 1445 Ross Avenue, Dallas, TX, 75202-2799, US

(21) Appl. No.: 10/759,651

(22) Filed: Jan. 16, 2004

Related U.S. Application Data
(60) Provisional application No. 60/448,048, filed on Feb. 18, 2003.

(51) Int. Cl. F16L 1/12; E02B 17/08; B63B 21/00

(52) U.S. Cl. 405/205; 405/203; 405/169; 114/230.1

(57) ABSTRACT

The disclosed catenary anchor leg mooring system includes a cylindrical hull portion which reduces the tendency of the cylindrical hull to roll and pitch in response to the action of winds and waves. This motion reduction comes from changing the diameter and draft of the cylindrical hull.

### REFERENCE TO RELATED APPLICATION

This application claims priority from U.S. Provisional Patent Application Serial No. 60/448,048 filed Feb. 17, 2003.

### BACKGROUND OF THE INVENTION

1. Field

The present invention pertains to the production of crude oil from subsea reservoirs, more particularly, the present invention pertains to a system for facilitating a flow connection between a subsea reservoir and a tanker vessel.

2. Background

Catenary anchor leg mooring (CALM) systems have been used by the offshore oil production industry for several years. As shown in FIG. 1, a typical mooring system, located on the sea surface, typically includes a hollow cylindrical hull portion 20 which is about 8-12 meters in diameter and about 4-5 meters high. The center of gravity of the cylindrical hull portion is located near the water line. While located at the sea surface, the cylindrical hull portions are anchored to the seabed 22 by 6 to 8 catenary chain/wire mooring lines 25.

The top of the cylindrical hull portion 20 of some prior art CALM systems is typically fitted with a turntable 30. A vessel, such as a tanker 40, can then be moored to the turntable by a hawser 35. Once the vessel is moored, a fluid swivel 50 is connected, at its lower end, to rigid steel submarine catenary flow lines 45 which extend upwardly from subsea wells. The flow lines 45 are connected through the fluid swivel 50 to floating hoses 55. Such connections allow a surface vessel 40— such as a tanker—to be loaded or unloaded with oil flowing through the rigid steel submarine catenary flow lines 45 thence thruogh the floating hoses 55 while the tanker 40 weathervanes in response to the wave, current, and wind forces at the sea surfaces.

The small relative size of the cylindrical hull portion 20 of a CALM system, compared to the size of offshore waves, results in a flow connection system whose movement is characterized by pitching and rolling. Generally, an attempt is made to suppress the pitching and rolling of the cylindrical hull portion 20 by adding damping plates around the periphery of that part of the cylindrical hull portion 20 which is underwater. However, it has been found that while the use of damping plates provides some reduction in both pitching and rolling, the use of damping plates does not provide a satisfactory solution in very rough seas.

The key drawback of prior art CALM systems becomes apparent when one tries to support rigid steel submarine flow lines 45 from the cylindrical hull 20, particularly if the connection between the cylindrical hull 20 and the rigid steel submarine flowline 45 is a so-called elastomeric joint. The combination of the pitching and rolling motions, together with the heave and surge response of the cylindrical hull portion 20 to both wave forces and surface swells, is such that it is difficult to achieve acceptable fatigue lives for the rigid steel submarine catenary flow lines 45 up to a tanker 40 floating on the surfaces.

Accordingly, there remains a need in the art to provide a catenary leg anchor mooring system that will adequately endure wave forces and surface swells.

### SUMMARY

The present invention provides a catenary anchor leg mooring system that adequately endures wave forces and surface swells.

Included in the catenary leg anchor mooring system of the present invention is a floating buoy assembly. The floating buoy assembly includes a ballasted cylindrical hull portion whose geometry is selected to minimize pitching and rolling. The ballast spaces may be located both above and below the water line. The system further includes the required connections and hoses to provide a fluid patch for crude oil from subsea reservoirs to a tanker vessel. Use of the disclosed system minimizes fatigue on the rigid steel submarine flow lines attached thereto.

### BRIEF DESCRIPTION OF THE DRAWING FIGURES

A better understanding of the catenary anchor leg mooring system of the present invention may be had by reference to the drawing figures, wherein:

FIG. 1 is an elevational view of a typical prior art CALM mooring system;

FIG. 2 is an elevational view of a deep-draft version of a prior art cylindrical hull portion of the CALM system of the present invention; and

FIG. 3 is an elevational view of a large diameter CALM buoy according to the present invention.

### DESCRIPTION OF THE EMBODIMENTS

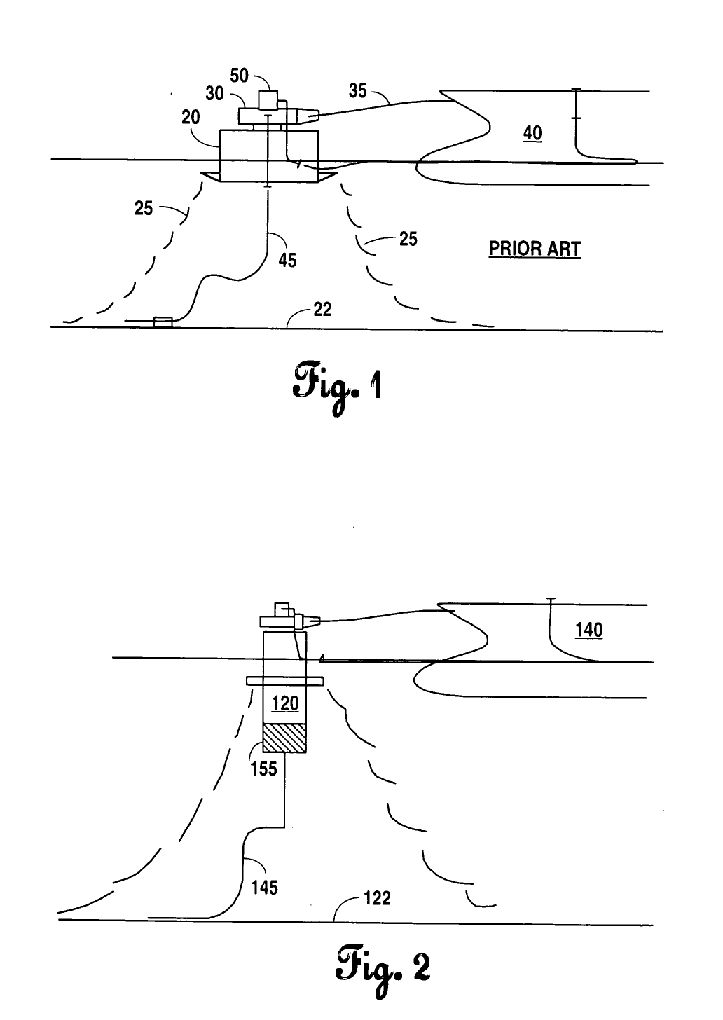

A solution to the problem of fatigue of the rigid steel submarine flowlines in prior art catenary anchor leg mooring systems involves selecting a geometry for the shape of the cylindrical hull portion 120 of a CALM system 100 which reduces the pitching and rolling motions caused by wind and wave forces. Such a CALM system 100 is shown in FIG. 2. This reshaping of the cylindrical hull portion 120 of the CALM system 100 places the center of gravity below the water line. This change in the location of the center of gravity has the effect of diminishing the motion responses which plague prior art systems. Because the motion response of the disclosed CALM system is diminished, the fatigue damage of the rigid steel submarine flowline 145 is also reduced. The mooring of the cylindrical hull portion 120 to the sea bottom is accomplished by the use of the mooring lines 25 as in prior art systems.

It has also been found that the addition of ballast material 155 in a compartment 156 at the bottom of the cylindrical hull portion 120 further lowers the center of gravity. Ballast material 155 may be required to increase inertia thereby providing additional stability where extreme motion conditions may be encountered.

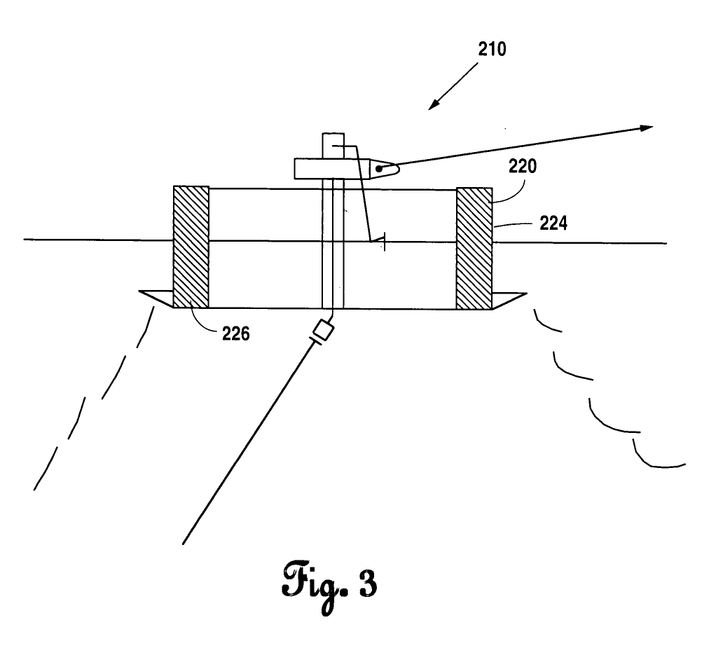

Shown in FIG. 3 is yet another embodiment 200 of the present invention. In this embodiment, the cylindrical hull portion 220 is characterized by a diameter which is more than two times the height of the cylindrical hull portion. The outer rim 224 of the cylindrical hull portion 220 is fitted with a substantially cylindrical ballast compartment 226, extending both below and above the water line, which follows the circumference of the cylindrical hull portion 220. These ballast spaces 226 are filled with water upon installation of the cylindrical hull portion 220 above an offshore oilfield. The cylindrical hull portion 220 when ballasted exhibits very high inertia against rolling and pitching motions because the location of its center of gravity is below the water line.

While the present system and method has been disclosed according to preferred and alternate embodiment of the invention, those of ordinary skill in the art will understand that other embodiments have also been enabled. Such other embodiments shall fall within the scope and meaning of the appended claims.

What is claimed is:

1. A catenary anchor leg mooring system for use in the production of oil from subsea reservoirs comprising:
a hollow buoy assembly for floating on the sea surface,
said hollow floating buoy assembly including a cylindrical hull portion having a center of gravity which is below the sea surface;
said shallow draft cylindrical hull portion further including a ballast compartment having a portion below the sea surface;
means for providing a path for oil to travel from the subsea reservoirs to a tanker.

2. The catenary anchor leg mooring system as defined in claim 1 wherein said ballast compartment is constructed and arranged to be filled with sea water.

3. The catenary anchor leg mooring system as defined in claim 1 wherein said ballast compartment is constructed and arranged to increase the inertia of said shallow draft cylindrical hull portion to reduce the roll and pitch of said cylindrical hull portion in response to wind and wave forces.

4. The catenary anchor leg mooring system as defined in claim 1 wherein said cylindrical hull portion has a diameter which is greater than two times its height.

5. The catenary anchor leg mooring system as defined in claim 4 wherein said ballast compartment is substantially cylindrical and follows the circumference of said cylindrical hull portion.
